(19) United States
(12) Patent Application Publication
(10) Pub. No.: US 2003/0049485 A1
(43) Pub. Date: Mar. 13, 2003

(54) Corrosion control coatings

(76) Inventors: John M. Brupbacher, Baltimore, MD (US); Mark F. Mosser, Perkiomenville, PA (US); Scott E. Vogt, Catonsville, MD (US)

Correspondence Address: Drinker Biddle & Reath LLP, One Logan Square, 18th and Cherry Streets, Philadelphia, PA, 19103-6996, US

(21) Appl. No.: 09/948,242

(22) Filed: Sep. 6, 2001

(51) Int. Cl. B32B 15/08

(52) U.S. Cl. 428/615; 428/626; 428/621

(57) ABSTRACT

The present invention provides long-lived corrosion resistant coatings for metal substrates. The coatings comprise a chemically stable mechanical attachment interface formed by coating a metal substrate with a seamless thermal spray metallic coating of a Ni-based alloy or stainless steel, and a polymer layer bonded to the metallic interface. The coatings are suited for resisting corrosive environments in process chemistry vessels, furnaces and boilers.

### FIELD OF THE INVENTION

This invention relates to the field of corrosion resistant coatings on metallic substrates. In particular, the invention is concerned with corrosion resistant coatings on chemical process equipment.

### BACKGROUND OF THE INVENTION

Throughout the latter half of the twentieth century, demands for greater production efficiency in the chemical process industry have caused manufacturers to use increasingly higher reaction temperatures and pressures, and more corrosive catalysts. The need to contain corrosive liquids under these harsher conditions, and the need for reaction vessels that would not suffer inordinate damage or degradation from corrosion with time and use, has driven the development of corrosion resistant materials and coatings for use in chemical process equipment.

For example, stainless steel was initially designed for containment of nitric acid. The Ni-based “superalloys,” which exhibit resistance to a wider range of corrosive environments, were then developed. See, e.g., Rebak R B and Cook P, “Nickel Alloys for Corrosive Environments,” Advanced Materials and Processes (February 2000), pgs. 37-42; Agarwal D C “Corrosion Control with Ni—Cr—Mo Alloys,” Advanced Materials and Processes (August 2000), pgs. 27-31. There are now a number of advanced alloys that can be used to fabricate corrosion resistant process vessels or form corrosion resistant coatings. Such alloys include various ferrous and nickel based materials, such as Inconel®, Incoloy®, and the Hastelloy® alloys.

Each alloy has its particular advantages and disadvantages in specific process chemistries, although all are susceptible to corrosion over time or in particular environments. For example, certain alloys are sensitive to changes in the composition of processing fluids (e.g., the corrosion resistance of stainless steel can be markedly degraded by chloride contamination of the process fluid). The limitations of corrosion resistant materials are known, and those skilled in the art are capable of selecting the proper alloy for specific applications. See, e.g., Jennings H S (2001) “Materials for Hydrofluoric Acid Service in the New Millennium,” Corrosion 2001, paper 01345 (which discusses selection of alloys for use in hydrofluoric acid environments); Rebak R B and Cook P, supra; and Agarwal, supra. Despite their limitations, these specialized corrosion resistant alloys have enjoyed widespread use.

Fabrication of chemical process equipment entirely from specialized corrosion resistant alloys is expensive and time consuming. Thus, some manufacturers line inexpensive steel equipment with glass. Glass is impervious, nearly chemically inert, and has good thermal conductivity. However, glass is brittle and subject to accidental mechanical damage and degradation from cavitation and abrasion. Also, fluoride and various alkaline fluids will dissolve glass. The lining of steel components with glass is therefore not an ideal method for producing corrosion-resistant equipment.

Another alternative to the use of expensive, corrosion-resistant alloys for constructing chemical processing equipment is the use of various overlay techniques to attach the alloys to relatively low-cost, mild steel equipment. These processes include welding the alloy to the substrate using strip and sheet overlay application techniques (for example, those employing shielded torch, laser and electron beam energy sources), and explosive cladding. Explosive cladding differs from the weld overlay approaches in that the alloy liner material is intimately and uniformly attached to the substrate material. However, these techniques are cumbersome, and are not well suited for repairing existing chemical process equipment that has been damaged by corrosion or cracking. Also, corrosive agents may penetrate to the substrate at weld points and seams in the lining material.

Corrosion resistant alloys may also be applied to metallic substrates with thermal spray coating techniques. A benefit of thermal spray coating techniques is that an inexpensive base metal, such as carbon steel, can be treated to create new surface properties that are far superior to that of the base metal. Thermal spray coatings may therefore save costs associated with fabrication of entire structures from prohibitively expensive superalloys. Thermal spray techniques are also generally less costly and easier to perform than weld overlay or cladding techniques.

An ideal thermal spray coating has a density which approaches the density of a solid metal structure having the same composition as the composition being thermally sprayed. Thus, the “density of a coating” as used herein refers to the ratio of the measured density of the coating to the absolute density of a perfectly solid material of the same composition, expressed as a percentage. Thus, an ideal thermal spray coating has a coating density of 100%.

Processes for the thermal spray coating of corrosion resistant coatings onto metallic substrates include the following (listed from the least costly techniques that produce coatings that are the least dense and of lower perceived quality, to more costly techniques that produce coatings that are more dense and of higher perceived quality):

(1) Combustion powder/wire (“Flame spraying”)—Combustion flame spraying employs compressed air or oxygen mixed with one of a variety of fuels (e.g., acetylene, propylene, propane, hydrogen), to both melt and propel the molten metal particles of the coating onto the substrate. The coating feedstock material can be either powder, wire or rod. Combustion flame spraying provides for a thermal coating having a density of approximately 85-90%. This technique has found widespread usage for its relative simplicity and cost effectiveness.

(2) Arc wire—Arc wire spraying involves feeding corrosion resistant coating material in the form of two current-carrying electrically conductive wires into a common arc point, at which melting of the coating material feedstock occurs. A high-velocity air jet blowing from behind the moving wires strips away the molten coating material which continuously forms as the wires are melted by the electric arc. Arc wire spraying provides for a thermal coating having a density of approximately 80-95%.

(3) Plasma spray—A plasma gun operates on direct current, which sustains a stable non-transferred electric arc between a cathode and an annular anode. A plasma gas is introduced at the back of the plasma gun interior, the gas exiting out of the front of the anode nozzle. The electric arc from the cathode to the anode completes the circuit, forming an exiting plasma flame. The corrosion resistant coating material, in the form of a powder, is introduced at this hottest part of the flame. Plasma spray is used to form coatings of greater than 50 micrometers from a wide range of industrial materials, including nickel and ferrous alloys, refractory ceramics, such as aluminum oxide and zirconia-based ceramics. Plasma spraying provides for a thermal coating having a density of approximately 90-95%.

(4) High Velocity Oxyfuel Spraying (HVOF)—This technique is based on special torch designs, in which a compressed flame undergoes free-expansion upon exiting the torch nozzle, thereby experiencing dramatic gas acceleration up to supersonic speeds. By injecting the corrosion resistant coating material as a feedstock powder from the rear of the torch, and concentrically with the flame, the molten particles of the coating material are also accelerated to supersonic speeds. Upon impact onto the substrate, the particles spread out very thinly, and bond well to the substrate and to all other “splats” in the vicinity, yielding a well adhered, dense coating. HVOF spraying provides for a thermal coating having a density of greater than 95%.

(5) Shrouded HVOF—This technique consists of HVOF spraying carried out with a gaseous, mechanical or physical barrier designed to reduce the ingress of air into the system. This creates a reduced pressure zone and reduces oxidation of the molten corrosion resistant coating material particles being sprayed. Gas and particle velocity are significantly increased within the reduced pressure zone, which results in a higher density coating. Shrouded HVOF spraying provides for a thermal coating having a density of greater than 95%.

Using these techniques, a wide variety of corrosion resistant alloys and composites can be applied to metallic substrates to form coatings with different bond strengths, thicknesses, porosity, oxide contamination, residual stresses, and surface finishes. Selection of the most appropriate thermal spray technique is a tradeoff among desired properties, cost, equipment availability and ease of application.

Thus, while it would be desirable to consistently employ techniques which produce the highest density coating, this is not always practicable. Moreover, extremely dense coatings (e.g., greater than 98%) can be highly stressed. As such, coatings may have intercohesive bonding which is greater than adhesive forces holding the coating to the substrate. Coatings under such stress may de-bond (i.e., pull away from the substrate).

Thermal spray coating processes are typically performed under tightly controlled and ideal conditions, such as at a manufacturing plant or laboratory. The use of controlled conditions reduces the number of variables that effect the quality of the coating. In some cases, the spray coating must be deposited under inert shrouding or in a vacuum chamber. In particular, the more expensive thermal spray processes (plasma spray and HVOF) produce high quality coatings only when performed under tightly controlled conditions, such as at a manufacturing plant of in the laboratory. Furthermore, spray coating processes are typically performed on discrete, pre-assembled component parts, and not on fully assembled chemical process equipment.

Because spray coating processes are generally performed under controlled conditions and on discrete components, they are generally not practical where a thermal spray coating must be applied to an existing surface in situ.

Another factor affecting thermal spray coating quality is the geometry of the substrate. High powered thermal spray processes (such as plasma spray or HVOF) produce high quality, dense coatings only when the thermal spray stream impacts the surface of the substrate at a substantially perpendicular angle. Such deposition angles are normally not uniformly achievable when coating chemical process equipment (such as chemical reaction vessels) which have irregularly shaped surfaces; e.g., at fillets, heat exchangers, or welded areas.

Moreover, access to the surfaces of chemical process equipment is greatly limited by space constraints. The equipment necessary for applying thermal spray coatings is cumbersome, and it is often difficult and dangerous to position the equipment and operator inside the vessels and other structures. High-powered thermal spray coating equipment may have high amperage power associated with it or high pressure lines of explosive gases. HVOF systems in particular emit sound waves in excess of 130 decibels.

A significant drawback of thermal spray coating processes is the formation of porosity or voids in the coating, which results in coating densities below 100% (i.e., coating densities which are less than the density of the corresponding solid material of the same composition). These pores or voids are invariably formed during, or as a result of, any thermal spray process.

Porosity in the thermal sprayed coatings can originate from, inter alia, any of the following events in the coating process: material shrinkage on cooling from the liquid state; trapped, unmelted or partially melted particles, which form voids between adjacent particles; voids that remain unfilled by the splats; poor intra-splat cohesion; and separation of splats. As used herein, a “splat” is a droplet or particle from the thermal spray coating process that impacts on a substrate to form a layer. The splat is primarily metallic but will include oxides and other surface contaminants.

Pores can form interconnected channels which reach directly from a coating's outer surface to the underlying substrate, allowing corroding or oxidizing materials to attack the base metal. Porosity can thus destroy a coating's desired corrosion resistance. For example, use of HVOF to produce ultradense coatings does not create coatings of 100% metallic density. Corrosion attacks the oxide film on each splat creating a path to the substrate and subsequent corrosion of the substrate.

Because the coatings formed by thermal spray techniques are porous, noble materials or alloys such as the corrosion-resistant Hastelloy® C-276 are not generally used for corrosion control. The pores in the alloy coatings allow penetration of reactive material to the metal substrate, and may create a galvanic corrosion cell between the alloy coating and the more reactive substrate material. In particular, serious galvanic attack can occur on low alloy steel, cast iron and many “corrosion resisting” steels.

Corrosion resistant alloys and coatings formed from these alloys are often inadequate to control corrosion in the presence of the reagents and conditions employed in modern industrial process chemistry. These thermal spray coatings are porous and permeable and may be contaminated with oxides. Topcoat sealers have therefore been designed which overlay the alloy in the coating or vessel wall and further inhibit the corrosive activity of the process reagents.

For example, polymeric coatings or linings are widely used for corrosion and purity control of chemical processing equipment employed by, e.g., the chemical, pharmaceutical, metal and microelectronics processing industries. Polymers such as epoxies, nylon and fluoropolymers are widely used, but fluoropolymers are of particular interest because of the chemical stability, thermal stability and low extractables content. Polymeric coatings or linings can applied to substrate by a variety of techniques, including spraying of a liquid dispersion or powder, electrostatic or flocking spray of a powder, rotolining, transfer molding, sheet bonding, and bonding to a mesh screen.

A layer of polymer material located on the inside of a chemical process reaction vessel is typically called a “lining.” Polymer linings are often relatively thick to resist the harsher environment inside the vessel. Thinner layers of polymer materials located on the outside of chemical process reaction vessels are typically called “coatings.” Polymer coatings are often used on surfaces which come into contact with corrosive material intermittently or incidentally (such as by spilling or splashing), but need not resist the full corrosive conditions of the vessel interior.

For ease of illustration, the following discussion will refer to both polymer coatings and linings for use in corrosion control as “coatings,” regardless of their thickness or location on the substrate.

Fluoropolymers used as corrosion control coatings include both partially and fully fluorinated resins in the range of 1 mm (0.040 inch) to 2.5 mm (0.10 inch) or greater. Examples of partially fluorinated materials include polyvinylidene fluoride (e.g., Kynar®), ethylene chlorotrifluoroethylene copolymer (e.g., Halar®), and ethylene tetrafluoroethylene copolymer (e.g., Tefzel®). Fully fluorinated fluororesins used for coating and lining applications include FEP-tetrafluoroethylene hexafluoropropylene copolymer and PFA-tetrafluoroethylene perfluoroalkylvinyl ether copolymer.

The polymeric coatings of the prior art systems provide barrier protection for substrates such as reaction and storage vessels by reducing contact of the substrate with corrosive liquids and gases. However, these polymer coatings are not impervious to permeation of corrosive fluids, which may eventually penetrate the coating and become trapped on the substrate side of the coating, in contact with the substrate or alloy layer. This is particularly true for chemical process equipment which may operate at elevated temperatures and pressures.

The permeation of corrosive material through polymer coatings is generally not due to porosity of the coating, but is rather due to the physical/chemical structure of the polymer matrix itself. Conditions which affect the physical/chemical structure of the polymer matrix, such as elevated temperatures and pressures, generally enhance the rate of fluid and gas permeation through a polymer coating.

The permeation of corrosive fluid through the polymer coating to the backside of the coating is undesirable not only for reasons of contamination or corrosion of the substrate surface, but also for reasons of degradation of the chemical and/or mechanical bonding system securing the coating to the substrate.

The penetration of corrosive material through a polymer coating will cause corrosion of the substrate, which produces gaseous products and metal salts. These by-products of corrosion eventually cause delamination or debonding of the coating material. Indeed, fluoropolymer manufacturers recommend against applying a PFA fluoropolymer coating to nickel, Hastelloy® and stainless steel.

If there is a metallic coating underneath the polymer layer, permeation of corrosive material through the polymer layer may also result in galvanic corrosion of the substrate material. Galvanic corrosion requires two metals with different electrical potentials to be in contact with a particular corrodant. For example, a Ni-based coating will be cathodic and a mild steel substrate will be anodic in hydrochloric acid (HCl).

As discussed above, thermally sprayed metallic layers are porous and will allow corrosive material to penetrate to the underlying substrate. HCl in contact with a mild steel substrate through a pore in an overlying Ni-based coating creates a large cathode and a small anode at the pore. The large galvanic potential of such an HCl-filled pore causes a high rate of corrosion in the steel substrate, causing pitting and severe mechanical damage.

Other combinations of substrate, metallic coating and corrodant that are well-known to one of ordinary skill in the art may produce a galvanic cell.

Fluoropolymer layers are also difficult to bond to the underlying substrate or alloy layer. A number of techniques for enhancing attachment of fluoropolymers to metal substrates or alloy layers have been developed; for example, the use of primers, mechanical pre-treatments of the substrate, and mechanical bonding systems. Indeed, manufacturers of fluoropolymers such as PFA, ECTFE, and ETFE highly recommend the use of primers when attaching these compounds to metallic substrates. These bonding enhancement techniques are described below.

Mechanical Pre-Treatments

It is well known that smooth, highly oxidized or otherwise contaminated surfaces are not desirable for bonding of polymeric materials. For this reason, coating applicators will generally pre-bake process equipment to temperatures in excess of 371° C. (700° F.) or more to remove oil, grease and other coatings. Subsequently, the process requires an abrasive blast of the surface with hard sharp media such as aluminum oxide, silicon carbide, sand, or the like to produce a surface finish that is microscopically rough. The surface finish as measured by a stylus profilometer should be greater that 150 microinches (3.75 micron) at an 0.76 mm cutoff (equivalent to 0.030 inch cutoff) prior to coating. Also, it is well known that surfaces such as mild steel must be coated quickly after blasting or the bond strengths will be substantially degraded.

Primers

Primers are often used because of the non-wetting and non-bonding properties of the fluororesins. As coating films get thicker, bonding becomes more difficult because of the mismatch between the coefficients of thermal expansion of the metal substrate and fluororesin coating.

Use of primers may reduce or eliminate the thermally produced oxides that form a non-adherent surface on the substrate during processing, when the steel is heated to temperatures in excess of 399° C. (750° F.). Primers may also reduce or eliminate thermally unstable, non-adherent ferrous corrosion products that may be produced by water-induced corrosion of the steel during processing. As an excess of thermally produced oxides or ferrous corrosion products may cause the polymer coating to fail by delamination, polymer manufacturers generally recommend treating a substrate with a primer before applying a polymer coating. Primers also help create a tenacious bond between the polymers and bare blasted steel by promoting wetting and bonding of the fluororesin to the primer. Finally, many primers have properties that help alleviate adhesive or cohesive failure of the polymer layer induced by permeation of corrosive gasses and liquids behind to coating.

Mechanical Bonding Systems

Grit blasting often does not provide a suitably rough surface profile for bonding a fluoropolymer coating. Therefore, thermal spray techniques have been used to apply thin film, non-stick fluoropolymer coatings to layers of corrosion resistant alloy that has itself been applied by thermal spraying. Applying the fluoropolymer in this way enhances bonding and provides erosion and wear resistance. See, e.g., U.S. Pat. No. 5,069,937 of Wall. This technique is commonly used on cookware. The process employs a thin film of fluoropolymer resin coating applied over an arc wire thermal spray layer of corrosion resistant metal such as stainless steel. In such applications, the metal peaks of the thermally sprayed metal or alloy layer reside either slightly below the surface or protrude through the fluororesin coating. The metal peaks principally serve as a wear resistant, mechanically locking interface for the fluoropolymer. Such coatings, however, cannot be used in corrosive environments, as the corrosive material would have access to the alloy layer and eventually penetrate to the substrate.

Fluoropolymers have also been coated onto a mesh screen that has been welded to the vessel wall (or other component) to mechanically lock the resin into the mesh during the coating melting/curing process, as described in U.S. Pat. No. 2,690,411 of Seymour and U.S. Pat. No. 4,779,757 of Fuckert et al. Bonding of the fluoropolymer to the mesh eliminates the inherently weak fluoropolymer-metal bond from the attachment process; i.e., the mesh weldment must fail before the coating can separate from the process equipment. The fluoropolymer-bonded mesh can be welded over exotic alloys, but such chemically-robust weldments are unacceptably expensive for most applications.

The mesh may also have venting spaces between the corrosion resistant coating and the vessel wall, which allows the escape of gasses that have permeated through the coating. These include water and acidic gases (e.g. HF, HCl, SO₂, SO₃ and NO₂). Allowing the gas to escape prevents the delaminating of the coating from the vessel wall due to differential pressure buildup.

Despite the drawbacks discussed above, fluoropolymer coatings are widely used by chemical process manufacturers to enhance corrosion resistance.

The coatings formed from the materials and techniques described above are all subject to failure due to permeation of corrosive chemicals through even 100% dense coatings, and also through pores or seams in the coating layers. Indeed, corrosion rate of the coating often exceeds that of the mild steel substrate because of galvanic attack at the coating pores. The infiltrating corrosive agents may attack both the coating/primer layer and the underlying metal substrate, resulting in the premature disbonding and failure of the coating, which directly exposes areas of the substrate to the corrosive agents. Such corrosion markedly reduces the service life of the chemical process equipment.

Thus, there is a need for corrosion resistant coatings for chemical process equipment, which provide long-term corrosion resistance without delaminating or de-bonding under the harsh conditions typically encountered in the industrial chemical process industry. There is also a need for corrosion resistant coatings whose efficacy does not depend on the manner in which they are applied to the substrate, so the use of specialized equipment or tightly controlled conditions is not necessary to achieve the desired corrosion resistance.

### SUMMARY OF THE INVENTION

The present invention provides long-lived corrosion resistant coatings for metal substrates. These new coatings have corrosion resistance and control properties far superior to any previously known coatings. Furthermore, the corrosion resistance and control of the present coatings are unaffected by the manner in which the coating layers are applied.

The coatings comprise 1) a chemically stable mechanical attachment interface formed by coating a metal substrate with a seamless thermal spray metallic coating of suitable roughness, that is well-bonded and corrosion-resistant, and 2) a subsequently applied polymer layer comprising one or more polymers, for corrosion control. In one embodiment, the metal substrate comprises mild steel equipment. In another embodiment, the polymer layer comprises a fluoropolymer.

In one aspect, the invention provides a corrosion resistant coating for a metal substrate, comprising a thermally sprayed metallic layer comprising a nickel-based alloy or stainless steel with a thickness of at least about 0.125 mm (0.005 inch), and a polymer layer comprising one or more polymers over the metallic layer, with a thickness of at least about 0.5 mm (0.020 inch).

In another aspect, the invention provides a corrosion resistant coating for a metal substrate, comprising a thermally sprayed metallic layer comprising a nickel-based alloy or stainless steel overlaid by a polymer layer comprising one or more polymers, wherein the coating resists failure for at least 3 weeks, preferably at least 6 weeks, more preferably at least 10 weeks, and most preferably at least 30 weeks in an Atlas Cell according to ASTM protocol C868-85 (reapproved 1995) “Standard Test Method for Chemical Resistance of Protective Linings,” using hydrochloric acid at 20% concentration (˜2.4N) and at 80-85° C. (176-185° F.) as the corrodant.

In another aspect, the invention provides a metal substrate with a corrosion resistant coating, comprising a thermally sprayed metallic layer comprising a nickel-based alloy or stainless steel with a thickness of at least about 0.125 mm (0.005 inch), and a polymer layer comprising one or more polymers over the metallic layer, with a thickness of at least about 0.5 mm (0.020 inch).

In another aspect, the invention provides a metal substrate coated with a corrosion-resistant coating, comprising a thermally sprayed metallic layer comprising a nickel-based alloy or stainless steel overlaid by a polymer layer comprising one or more polymers, wherein the coating resists failure for at least 3 weeks, preferably at least 6 weeks, more preferably at least 10 weeks, and most preferably at least 30 weeks in an Atlas Cell according to ASTM protocol C868-85 using hydrochloric acid at 20% concentration (˜2.4N) and at 80-85° C. (176-185° F.) as the corrodant.

In a further aspect, the invention provides a chemically stable mechanical attachment interface for fluoropolymer-based corrosion control coatings, wherein the interface comprises a thermally sprayed metallic layer coating comprising a nickel-based alloy or stainless steel with a thickness of at least about 0.125 mm (0.005 inch). In one embodiment, the interface has surface roughness of at least about 3.215 microns Ra (125 microinches Ra) as measured by stylus profilometry.

In yet a further aspect, the invention provides a method of coating a metal substrate with a corrosion resistant coating, comprising the steps of 1) providing a metal substrate; 2) forming a stable chemical attachment interface on the metal substrate by coating the metal substrate with a seamless thermal spray metallic coating comprising a nickel-based alloy or stainless steel, wherein the metallic layer has a thickness of at least about 0.125 mm (0.005 inch); and 3) applying a polymer layer over the metallic layer, wherein the polymer layer comprises one or more polymers and has a thickness of at least about 0.5 mm (0.020 inch).

In a still further aspect, the invention provides a method of coating a metal substrate with a corrosion resistant coating, comprising the steps of 1) providing a metal substrate; 2) forming a stable chemical attachment interface on the metal substrate by coating the metal substrate with a seamless thermal spray metallic coating comprising a nickel-based alloy or stainless steel; and 3) applying a polymer layer comprising one or more polymers over the metallic layer, wherein the coating resists failure for at least 3 weeks, preferably at least 6 weeks, more preferably at least 10 weeks, and most preferably at least 30 weeks in an Atlas Cell according to ASTM protocol C868-85 using hydrochloric acid at 20% concentration (˜2.4N) and at 80-85° C. (176-185° F.) as the corrodant.

### DETAILED DESCRIPTION OF THE INVENTION

The invention concerns corrosion resistance and control coatings for metal substrates, such as the interior surfaces of chemical process equipment, chemical storage and reaction vessels, pipes, pumps, valves, etc. The present coatings are also well suited for protection of exterior surfaces located in contaminating environments, such as elements of structures located in salt water.

The metal substrates may comprise any metal or alloy with adequate weldability, strength and other mechanical properties needed for a particular application, as is well-known in the art. For example, the metal substrate may comprise cast iron; low carbon steel; carbon steel; low alloy steel (e.g, 1Cr1Mo steel); stainless steel (e.g., 400 series stainless steels; 300 series stainless steels); and the like.

Particularly preferred substrates comprise chemical process equipment or any component of chemical process equipment, and include any metallic surface of such equipment or component that may come in contact with corrosive substances. For example, substrates may comprise closed or open reaction vessels, and components of such vessels. Such components include, for example: shells, heads, reactor plates, columns, buckets, tubes, containers, and the like, and any surfaces thereof.

In one embodiment, the substrate may comprise a furnace or boiler, or a component thereof, such as are well-known to those of ordinary skill in the art. For example, the substrate may comprise a component located in the process stream or flue gas stream of the furnace or boiler, such as a scrubber. Preferred substrates are scrubbers designed to reduce HF, HCl, SO₂, SO₃, Cl₂ or ClO₂ emissions from flue or off-gases.

The coating is applied to the metal substrate by first applying a seamless thermal spray metallic coating of suitable roughness, that is well-bonded and corrosion-resistant.

The metallic layer may comprise any metal or alloy that is corrosion resistant to the specific corrosive environment. One of ordinary skill in the art can readily determine the type of metal or alloy suitable for use with a particular environment. For example: Ni metal may be used primarily for caustic solutions; Ni—Cu alloys may be used for mild reducing solutions, such as hydrofluoric acid; Ni—Mo alloys may be used in strong reducing environments; Ni—Fe—Cr alloys may be used in oxidizing environments; Ni—Cr—Si alloys may be used in “super” oxidizing environments; and Ni—Cr—Mo alloys may be used in all corrosive environments. As used herein, “reducing” and “oxidizing” refer to the nature of the reaction at cathodic sites during corrosion.

Specific Ni-based alloys and stainless steels suitable for forming the metallic layer are known, for example as disclosed in Rebak R B and Cook P, “Nickel Alloys for Corrosive Environments,” Advanced Materials and Processes (February 2000), pgs. 37-42; Agarwal DC “Corrosion Control with Ni—Cr—Mo Alloys,” Advanced Materials and Processes (August 2000), pgs. 27-31; and Jennings H S (2001) “Materials for Hydrofluoric Acid Service in the New Millennium,” Corrosion 2001, paper 01345, the disclosures of which are herein incorporated by reference in their entirety.

For example, suitable Ni-based alloys include, but are not limited to: Hastelloy® C-276 available from Haynes International (UNS No.: N10276); INCONEL® alloy 625 (UNS No.: N06625) and INCONEL® alloy 718 (UNS No.: N07718), both available from INCO Alloys International; nickel/chrome 80/20; nickel/chrome50/50; nickel copper alloys such as MONEL® 400 (UNS No.: N04400), MONEL® R-405 (UNS No.: N04405) and MONEL® K-500 (UNS No.: N05500), all available from available from INCO Alloys International; 95/5 Ni/Al; and nickel containing stainless steels such as 304SS, 316SS, and Alloy 20 and similar “super” austenitic stainless steels. The Ni—Cr—Mo alloys, in particular Hastelloy® C-276 and INCOLOY® alloy 625, are preferred for forming the metallic layer.

The metallic layer may be applied by any thermal spray technique, which are well-known in the art. For example, the invention may be practiced with any of the thermal spray processes discussed above. The particular thermal spray technique has no observable effect on the corrosion resistance of the ultimate coating, so the simpler and less expensive techniques (such as arc-wire spraying) may preferably be used.

Different thermal spray techniques may be combined to apply a coating to a single substrate. For example, HVOF thermal spray techniques may be used in certain high stress areas of a substrate, while arc wire spray may be used for the remainder of the substrate. Alternatively, some of the coating thickness in a given area may be applied with an HVOF gun, and the remaining thickness in the same area may be applied with an arc wire gun.

For ease of illustration, the following discussion and examples demonstrate the application of the metallic layer to the substrate with a standard arc-wire thermal spraying technique. It is understood, however, that the invention is not limited to the use of arc-wire thermal spraying, but that any thermal spraying technique or combination of techniques may be used.

To apply the metallic layer, the substrate is typically heated to a high temperature (e.g., greater than approximately 371° C. (700° F.)) to eliminate oil, grease and other coatings. This is called the “preheat” or “burnout” step. The temperature to which the substrate is heated may be as high as 482° C. (900° F.), and this temperature may be held for several hours depending on the oven and the cross section mass of the component. One of ordinary skill in the art can readily determine the temperature and time required to adequately prepare the substrate for thermal spraying of the metallic layer.

Following the preheat or burnout step, the substrate is abrasive blasted. Any suitable abrasive blasting technique may be used, as is known in the art. Suitable grit size of the abrasive may be 12 to 20 or 16 to 20 mesh, although other mesh sizes may be used. The resulting profile on the substrate being processed is dependant on factors such as the grit size, grit hardness, nozzle size, distance from work to nozzle orifice and blasting pressure. For example, abrasive blasting of the substrate may be carried out with SSPC-SP5/NACE No. 1 White Metal Blast Cleaning Standard, using Steel Structures Painting Council Abrasive Specification No. 1.

Any standard arc wire spray gun may be used to apply the metallic layer to the processed substrate. For example, a metallic layer of a Ni—Cr—Mo alloy, such as Hastelloy® C-276 wire, may be applied to a processed substrate with a Praxair Tafa 8830 Arc Spray gun, using published standard spraying parameters.

Any suitable metal or alloy may be used to form the metallic layer, as discussed above. One of ordinary skill in the art may readily determine the appropriate thermal spray technique for a particular metal or alloy. For example, some alloys are not commercially available in wire form, and thus cannot be easily applied with the arc wire system. However, the alloy may be available in powder form suitable for other thermal spray techniques, such as plasma spray or HVOF.

The metallic thermal spray layer may be applied to a thickness of at least about 0.125 mm (0.005 inch), and is preferably applied in a thickness from about 0.25 mm (0.010 inch) to about 0.5 mm (0.020 inch), more preferably applied in a thickness from about 0.25 mm (0.010 inch) to about 0.375 mm (0.015 inch).

The thermally sprayed metallic layers are generally rough. The roughness of the layers may be varied by altering certain parameters of the thermal spray technique. For example, a smoother surface may be produced by increasing the atomization of the spray (e.g., by increasing atomizing air or other gas), or increasing the heat and/or velocity of the molten metallic particles before they impact the substrate.

It is understood that the surface roughness of thermally sprayed metallic coatings is a function of the particular technique, equipment, protocol and materials used. One of ordinary skill in the art is capable of estimating or adjusting surface roughness in view of these parameters. Furthermore, measurement of surface roughness is not easily reproducible. Thus, the surface roughness of the thermally sprayed metallic layer of the present invention is not critical, as long as the overlaying polymer layer is well-bonded to the metallic layer. However, for purposes of the present invention, it is preferred that the surface roughness of the metallic layer surface (as measured by stylus profilometry) be at least about 3.125 microns Ra (125 microinches Ra), and more preferably at least about 5 microns Ra (200 microinches Ra).

As discussed above, the metallic thermal spray coatings are porous, and thus do not exhibit adequate corrosion resistance in and of themselves. This was confirmed in Example 2 below, where a steel panel coated with Hastelloy® C-276 to a thickness of 0.375-0.5 mm (0.015-0.020 inch) (see Example 1), was tested for porosity by placing it in a salt fog test chamber (per ASTM B 117-97) for 18 hours. At the end of the time period, the coating surface was covered with red iron oxide created at the substrate-coating interface, indicating permeation of the metallic thermal spray layer by the salt fog, and demonstrating that the metallic layer is not resistant to corrosion even in a mildly corrosive salt environment. The lack of corrosion resistance of the metallic layer alone was also demonstrated in Example 15 below, in which a steel panel coated only with Hastelloy® C-276 exhibited gas bubbles in and on the coating surface when immersed in an Atlas Cell under highly corrosive conditions. These bubbles indicated that there is significant reactivity between the acid and the Hastelloy® or the substrate due to pores in the Hastelloy® coating. Such reactions are not unexpected, and have heretofore led people not to use such thermally sprayed coatings, either alone or underneath polymer coating layers, for corrosion resistance.

In the present invention, a polymer layer is applied over the metallic thermal spray layer to render the coatings corrosion resistant. Such coatings are able to resist failure for at least 3 weeks when tested in an Atlas Cell according to ASTM protocol C868-85 (reapproved 1995) “Standard Test Method for Chemical Resistance of Protective Linings” (herein incorporated by reference in its entirety), using hydrochloric acid at 20% concentration (˜2.4N) and at 80-85° C. (176-185° F.) as the corrodant. These conditions are considered extremely corrosive.

Preferably, the coatings and coated substrates of the invention are able to resist failure in the ASTM C868-85 Atlas Cell test for at least 6 weeks, more preferably for at least 10 weeks, and most preferably for at least 30 weeks.

The polymeric material applied over the metallic thermal spray layer may comprise polymer which is resistant to attack by corrosive fluids.

Suitable corrosion-resistant polymeric material includes, for example: polyether sulfone (PES), polyphenylene sulfide (PPS) and polyether ether ketone (PEEK), polyphenylene oxide (PPO), and the like; elastomers (e.g., fluoroelastomers); epoxy; nylon; chlorinated rubber; polyurethane; polyurea; fluoropolymers; and other halogen-containing polymers.

Structures and physical properties of fluoroelastomers are described in Arcella V and Ferro R, “Fluorocarbon Elastomers,” in Modern Fluoropolymers (Scheirs J, ed.), John Wiley & Sons, New York, 1997, pgs. 71-90, the disclosure of which is herein incorporated by reference.

The term “fluoropolymer” is meant to identify a polymer in which one or more repeating subunits contains at least one fluorine atom. Fluoropolymers may be partially or fully fluorinated polymers.

Suitable fully fluorinated polymers include polytetrafluoroethylene (PTFE), fluorinated ethylene-propylene copolymer (FEP), and perfluoroalkoxy-tetrafluoroethylene copolymer (PFA).

PFA are well-known to those of ordinary skill in the art. These polymers are produced by radically copolymerizing tetrafluoroethylene with perfluoroalkylvinyl ethers, for example perfluoropropyl vinylether. The typical vinylether content is from about 1-5 mol %, and the molecular weight is approximately 1-5×10⁵ g/mol. A description of the physical/chemical characteristics of PFA and processes for their preparation is found in Hintzer K and Lohr G, “Melt Processable Tetrafluoroethylene-Perfluoropropylvinyl Ether Copolymers (PFA),” in Modern Fluoropolymers (Scheirs J, ed.), John Wiley & Sons, New York, 1997, pgs. 223-237, the disclosure of which is herein incorporated by reference. One particular form of PFA which is suitable for the present coatings is tetrafluoroethylene-perfluoromethylvinylether copolymer (MFA). Another preferred PFA perfluoropolymer is perfluoropropylvinylether copolymer.

Examples of partially fluorinated polymers suitable for use in the present invention include ethylene-chlorotrifluoroethylene copolymer (ECTFE), ethylene-tetrafluoroethylene copolymer (ETFE) and polyvinylidene fluoride (PVDF), although these materials are less chemically resistant than the fully fluorinated polymers.

Examples of commercially available polymeric material suited for use in liquid dispersion coating processes according to the present invention include, but are not limited to: FLUOROSHIELD™, a PFA of W. L. Gore & Associates of Newark, Del.; RUBY RED™, a PFA of E. I. DuPont de Nemours of Wilmington, Del.; and DYKOR™ 404, an ECTFE of Whitford Corporation of West Chester, Pa.

Examples of commercially available polymeric material suited for use in a powder coating process according to the present invention include, but are not limited to: TEFLON™, a PFA of E. I. DuPont de Nemours of Wilmington, Del.; HYFLON™, an MFA of Ausimont USA Inc. of Thorofare, N.J.; HALAR™, an ECTFE of Ausimont USA Inc. of Thorofare, N.J.; AFLON™, an ETFE of AGA Chemicals of Charlotte, N.C.; NEOFLON™, an FEP supplied by Daikin America, Inc. of Orangeburg, N.Y. ; and KYNAR™, a PVDF sold by Atofina Chemicals of Philadelphia, Pa.

It is understood that the invention is not limited to coatings comprising a single polymers, but that mixtures of one or more polymers, layers of different polymers, or mixtures of one or more polymers and fillers such as mica or talc (as disclosed, for example, in U.S. Pat. No. 5,972,494 of Janssens, the disclosure of which is incorporated herein by reference in its entirety) may be used. A mixture of PFA and PTFE is preferred, for example as described in GB 2,051,091A, the disclosure of which is incorporated herein by reference in its entirety.

The polymer layer may be at least about 0.5 mm (0.020 inch) thick, and may be from about 0.5 mm (0.020 inch) to about 3 mm (0.120 inch) thick, preferably from about 0.75 mm (0.030 inch) to about 3 mm (0.120 inch) thick, more preferably from about 1 mm (0.040 inch) to about 2 mm (0.080 inch) thick, particularly preferably about 1 mm (0.040 inch) to about 1.5 mm (0.060 inch) thick.

Suitable processes for applying a polymeric layer according to the present invention are well known in the art, and include, but are not limited to, spraying techniques (e.g., spraying of a liquid dispersion in a spray and bake process, and electrostatic or flocking spray of a powder), rotolining of a powder, transfer molding, sheet bonding, and bonding to a mesh screen. It is understood that any method which allows a polymer coating layer to be applied over the thermally sprayed metallic layer may be used in the present invention.

For example, coating powder may be dispersed in a fluid and then sprayed as a slurry, for example with a standard or electrostatic gun. The fluid used to suspend the polymer powder may be any suitable liquid such as water, glycols, polyols, aromatic solvents, etc., and may be formulated with pigments, surfactants, and other additives.

U.S. Pat. No. 4,321,177 of Wilkinson, which is incorporated herein by reference in its entirety, describes a spray and bake process which involves the spraying of a liquid dispersion containing the polymeric material at room temperature, for subsequent heating of the substrate above the melt temperature of the polymeric material. The placement of the polymeric material at room temperature is advantageous, particularly in applications where access to the substrate surface is limited, such as when coating the interior surface of a vessel.

Spray application of a dispersion containing one or more pigments is described in U.S. Pat. No. 5,972,494 of Janssens, supra, the disclosure of which is incorporated herein by reference in its entirety. As described therein, the polymer coating layer is typically applied to a substrate which is then heated above the melt temperature of the polymer.

Rotolining processes comprise the “charging” of a substrate (in particular the inner surfaces of the substrate) with polymer resin, sealing the substrate, and heating the substrate while rotating it to melt the resin and cause it to flow onto the surfaces. Such techniques are well-known in the art, for example as described in Khaladkar P R, “Fluoropolymers for Chemical Handling Applications,” in Modern Fluoropolymers (Scheirs, J., ed.), John Wiley & Sons, 1997, pg. 315, the entire disclosure of which is herein incorporated by reference.

Transfer molding techniques comprise forcing a charge of thermosetting or thermoplastic polymer material out of a holding vessel onto the substrate to be coated. The polymeric material is typically heated to a temperature approaching the polymerization temperature (or above the melting temperature if thermoplastic) and the substrate and components of the transfer molding apparatus are maintained at a suitably high temperature. Such techniques are well-known in the art, for example as described in O'Brien J C and Lenosky T, “Transfer Molding,” in Modern Plastics Encyclopedia (1988), pgs. 299-300, the entire disclosure of which is herein incorporated by reference. See also U.S. Pat. No. 5,773,723 of Lewis et al., the entire disclosure of which is herein incorporated by reference, for a description of a suitable transfer molding technique for fluoropolymers such as PFA, except that in the present invention, the fluoropolymer would be molded onto a thermally sprayed metallic layer rather than a perforated insert.

Techniques which do not apply the polymer coating directly to the thermal spray layer may also be used in the present invention. In particular, polymer sheets with or without a backing layer may be adhered to the thermally sprayed layer via an adhesive layer. Such techniques are generally termed “sheet bonding” or “sheet lining.”

For example, a bonded thermoplastic liner may be applied over the thermal spray layer with a suitable adhesive. Suitable bonded thermoplastic liners may have a bonding layer comprising a backing of fiberglass or other stable fabric pressed into the polymer resin at elevated temperature. The bonding layer is adhered to the thermal spray layer with a suitable adhesive such as an epoxy or elastomeric adhesive. It is preferred to use thermoplastic bonded liners comprising a fluoropolymer layer greater than about 1.5 mm (0.060 inch) thick. Typically, the bonded thermoplastic liners may be adhered to the thermoplastic layer without heating the substrate, thus making this a preferred process for coating large components.

Suitable bonded thermoplastic liners are well-known in the art, for example as described in Khaladkar P R, “Fluoropolymers for Chemical Handling Applications,” in Modern Fluoropolymers (Scheirs, J., ed.), John Wiley & Sons, 1997, pgs. 312 and 316-317; and “Coatings and Linings for Immersion Service” (revised ed.), TPC Publication 2, NACE Int'l (undated), pgs. 123-130, the entire disclosures of which is herein incorporated by reference.

Polymer sheets, in particular fluoropolymer sheets, that carry an adhesive layer may also be applied to the thermally sprayed layer. For example, fluoropolymer sheets (e.g., sheets of MFA, ECTFE or PCTFE) may be surface-modified by known techniques so that the sheet will retain an adhesive layer. For example, the surface of the polymer sheet may be modified to receive an adhesive by treatment with sodium in liquid ammonia, sodium napthalenide in tetrahydrofuran, or alkali metal amalgam; cold gas plasma surfacing; direct electrochemical reduction; and reduction with benzoin dianion. Such surface modification techniques are described in Brewis D M and Mathieson I, “Adhesion Properties of Fluoropolymers,” in Modern Fluoropolymers (Scheirs, J., ed.), John Wiley & Sons, 1997, pgs. 165-172, the entire disclosure of which is herein incorporated by reference.

After surface modification of the polymer sheet, a suitable adhesive (for example a silicone or acrylic pressure-sensitive adhesive) is then laminated onto the surface modified polymer sheet to form an adhesive surface. The polymer sheet may be adhered to the thermally sprayed layer by contacting the adhesive surface to the thermally sprayed layer. Generally, no additional heating or primers are required to achieve bonding between the thermally sprayed layer and the adhesive polymer sheet, thus making this a preferred process for coating large components. Preferably, adhesive sheets comprising a fluoropolymer layer of at least about 1 mm (0.040 inch) are used in the present invention.

A suitable commercially available adhesive sheet of this type is the FLUOROGRIP™ contact film supplied by Integument Technologies, Inc., of Towanda, N.Y.

Prior to applying the polymer coatings to the thermally sprayed substrate by any of the techniques described above, the coated substrate may be treated to enhance the attachment of the polymer. Such treatments are well-known in the art, and include grit blasting to remove oxidized films, grinding, primers, or mechanical attachment techniques such as wire mesh welded onto the coated substrate. However, a polymer layer may be applied to the metallic layer without any prior treatment of the metallic layer.

Wire mesh can be applied directly to the thermal spray metallic layer using standard techniques, as described in U.S. Pat. No. 2,690,411 of Seymour and U.S. Pat. No. 4,779,759 of Fuckert et al., the disclosures of which are herein incorporated by reference in their entirety.

For example, the wire mesh may be secured to the substrate by tack welding, or “micro-welding”, to achieve intermittent fusion of the mesh to the substrate without affecting the integrity of the substrate. In a known method, a resistance welding tool is directed over the mesh covered substrate to create a fusion between the mesh and the substrate as the welding tool contacts the threads of the mesh. The polymer layer is then applied to the mesh-covered substrate in a polymer coating process wherein melt flow of a polymer contained in a liquid dispersion or powder results in intermingling interaction between the threads of the mesh and the lining to interlock the lining and the mesh. The location of the mesh in flush contact with the surface of the substrate results in contact between the polymer and the substrate surface between the threads of the mesh. The mechanical interlocking of the lining to the mesh results in enhanced performance and extended life for chemical process equipment incorporating this system.

Generally, it is desirable to use a mesh of similar metallurgical composition, and preferably of the same alloy composition. For example, if a corrosion-resistant Hastelloy® C-276 alloy is applied as the metallic layer, then the preferred mesh material would be of a Hastelloy® C-276 composition. However, the mesh and metallic layer may be of different materials.

Mechanical mesh attachments for the polymer layer which provide for passages between the coating and the substrate may also be used. Preferably, the mesh is secured to the substrate surface and is at least partially embedded in the lining to secure the lining to the mesh. Structures, for example elongated spacers, are positioned between the mesh and the substrate and function to separate portions of the lining from the substrate surface such that the separated portions of the lining and the substrate define passageways for channeling fluid which may penetrate the lining. The passageways also allow gases that have permeated the coating to escape before delamination or debonding takes place.

The invention is illustrated by the following non-limiting examples.

### EXAMPLES

ASTM Standard Tests

The present coatings were evaluated by several standard test protocols published by the American Society for Testing and Material (ASTM). These protocols may be obtained through the ASTM's website at http://www.astm.org/.

The salt spray test ASTM B117-97 is used to evaluate performance of coatings by identifying pinholes or voids that lead through the coating to the substrate. In applications where the coating is thick and has no voids, pinholes or porosity, the test is not discriminating.

ASTM also prescribes test ASTM G31-72 (reapproved 1990), entitled Standard Practice for Laboratory Immersion Corrosion Testing of Metals. In this test, a sample is immersed in a test corrodant. Knowing the specimen surface area, temperature, aeration conditions, pressure, etc., it is possible to measure corrosion rates in milligrams per square centimeter per unit of time. However, this test does not adequately test thick fluoropolymers coatings, as such coatings are so resistant to corrosion under these test conditions that no meaningful data can be obtained within a reasonable time.

Because of this difficulty, thick film (e.g., greater than 0.375 mm (0.015 inch)) coatings are evaluated using ASTM C868-85 (reapproved 1995), “Standard Test Method for Chemical Resistance of Protective Linings.” As stated in para 1.1 of this protocol:

This test method covers a procedure for evaluating the chemical resistance of a protective lining applied to a steel substrate. The method closely approximates the service conditions, including the temperature differential between the external and internal surfaces of the equipment, which may accelerate permeation of the lining by a corrosive media. This test method may be used to simulate actual field use conditions insofar as a qualitative evaluation of the lining system after a predetermined period of exposure.

Thus, ASTM C868-85 is the generally accepted test method for evaluating thick film coatings and linings in chemical service. In the following examples, the ASTM C868-85 protocol is used, with hydrochloric acid at 20% concentration (˜2.4N) and at 80-85° C. (176-185° F.) as the corrodant. This produces an aggressive acidic environment at a very active temperature; i.e., there is water vapor and HCl vapor in the test cell.

The ASTM C868-85 protocol employs an apparatus called an “Atlas Cell,” which is designed to create a realistic “ΔT” condition across each panel to simulate the environment found in a chemical process reaction vessel. The Atlas Cell should force vapor and possibly liquid through a permeable coating or lining, thus creating condensation, corrosion of the substrate, and possibly a galvanic reaction.

ASTM protocols B117-97, G31-72, C868-85, and D714-87 (see Example 5 below) are herein incorporated by reference in their entirety.

### Example 1

A mild steel panel was heated to a temperature greater than 371° C. (700° F.) for 2 hours to eliminate oil, grease and other coatings. The panel was then abrasive blasted with SSPC-SP5/NACE No. 1 White Metal Blast Cleaning Standard, using Steel Structures Painting Council Abrasive Specification No. 1.

A layer of Hastelloy® C-276 was applied to the processed steel panel to a thickness of 0.25-0.375 mm (0.010-0.015 inch) with a Praxair Tafa 8830 Arc Spray gun, using Hastelloy® C-276 wire of the composition shown in Table 1.

TABLE 1
Hastelloy ® C-276 Wire Composition

| ELEMENT OR COMPOUND | ACTUAL WEIGHT % |
|---|---|
| C | 0.005 |
| Mn | 0.4 |
| Si | 0.02 |
| Cr | 15.90 |
| Ni | 58.66 |
| Mo | 15.4 |
| Co | 0.1 |
| W | 3.80 |
| V | <0.01 |
| Fe | 5.5 |
| RES. TOT | <0.004 |

The coating application was accomplished using published standard spraying parameters for the Hastelloy® C-276 wire, which are given in Table 2.

TABLE 2
Published Standard Spraying Parameters for Hastelloy ® C-276
Wire

| | Standard 8830 |
|---|---|
| Atomizing Air Pressure | 60 |
| Nozzle Cap | Green |
| Nozzle/Positioner (Cross = C; Slot = S) | Long C |
| Arc Load Volts | 30-32 |
| Amps | 100-300 |
| Standoff Inches | 4-5 |
| Coating Thickness/Pass-mils | 5 |
| Coating Texture-microinches aa | 400-600 |

### Example 2

The coated steel panel from Example 1 was tested for porosity by placing it in a salt fog test chamber for 18 hours, according to ASTM B 117-97 (this is considered a mildly corrosive environment). At the end of the time period, the surface of the coating was covered with red iron oxide originating at the interface between the mild steel and the Hastelloy® coating. This demonstrates that metallic thermal spray coatings by themselves are porous, and inadequate for immersion in even mildly corrosive environments such as salt water, let alone for use in the corrosive environments typically found in industrial process chemistry techniques.

### Example 3

An Atlas Cell test panel was degreased and aluminum oxide grit blasted with 20 mesh abrasive on one side. The panel was made of carbon steel and was 6.4 mm (0.25 inches) thick. The blast profile was 0.076-0.125 mm (0.003-0.005 inch). The panel was primed with DuPont 699-123 primer, which was not baked or cured. A first coating of ETFE powder (DuPont 532-6118) was applied to the panels using an electrostatic powder gun, and the panel was heated to 315° C. (600° F.) to melt and flow the powder.

The panel was then removed from the oven, hot flocked with additional ETFE powder, and returned to the oven. This process was continued until 40 mils (1 mm) of coating was applied to one side of the panel. When spark tested at 5,000 volts, the coating showed no pinholes or voids.

### Example 4

An Atlas Cell panel was prepared as in Example 3, except that after cleaning and grit blasting, it was thermally sprayed with Hastelloy® C-276 wire using a Tafa 8830 Arc Spray Gun, according to published recommended parameters for the gun and wire. 0.010 to 0.012 mils (0.25-0.30 mm) of Hastelloy® C-276 was applied to one side of the panel only. The panel was then coated with ETFE powder (DuPont 532-6118) without priming. The first ETFE coat was sprayed electrostatically; subsequent coats were hot flocked as described in Example 3, to the same thickness 1 mm (0.040 inch).

### Example 5

The panels from Examples 3 and 4 were attached to both sides of an Atlas Cell, and the Cell was operated per ASTM C868-85 using 20% hydrochloric acid (˜2.4N) at 80-85° C. (176-185° F.). The Cells were disassembled weekly to evaluate the condition of the panels.

After 6 weeks of testing, the primed ETFE specimen from Example 2, showed size 2, medium density blisters when rated per ASTM D714-87 (reapproved 1994) “Standard Test Method for Evaluating Degree of Blistering of Paints.” Such blistering is considered failure of the coating.

The panel from Example 3 (carrying the thermal spray metallic coating overlaid with a fluoropolymer layer) was tested for 40 weeks. No blistering or other failure was noted.

The absence of blistering, delamination, or any other signs of failure in the panel from Example 4 indicates that there is no measurable penetration of corrosive material through the coating system to the substrate. It is believed that the lack of penetration means that no galvanic cell can form, there will be no reduction or loss of adhesion between the coating and the substrate, and no corrosion of the substrate itself. Such results are completely unexpected, since the thermal spray layer is porous and permeable, and fluoropolymer coatings are permeable and allow corrosive material through to underlying layers.

### Example 6

An Atlas Cell panel was prepared as in Example 3, except that it was primed with ECTFE primer (Ausimont 5004) according to the manufacturer's instructions, and ECTFE powder (Ausimont 6014) was then applied using an electrostatic powder gun. The first ECTFE coat was sprayed electrostatically; subsequent coats were hot flocked as described in Example 2, to the same thickness (1 mm (0.040 inch)). When spark tested with 5,000 volts, the coating showed no pinholes.

### Example 7

An Atlas Cell plate was prepared as in Example 4, except that after thermal spraying with Hastelloy® C-276, it was coated with ECTFE powder as in Example 6. As in Example 4, no primer was used; only the thermal spray coating was used as an attachment mechanism. The ECTFE coating was 1 mm (0.040 inch) thick and showed no pinholes when spark tested with 5,000 volts.

### Example 8

The panels from Examples 6 and 7 were fitted onto an Atlas Cell and tested as described in Example 4. After 3 weeks, the panel of Example 6 showed blistering (size 2, medium density per ASTM D714-87). The panel from Example 7 showed no blistering or other failure in 16 weeks of testing, when the test was terminated.

The coating surface of the panels from Examples 6 and 7 was cut through the ECTFE lining layer using parallel cuts 2 cm apart, and cross cut at one end in an acid exposed area. The coating on the Example 6 panel peeled back, indicating a total lack of adhesion to the substrate. The coating of the Example 7 panel was solidly adhered to the substrate, and removal was only possible by chiseling and tearing off small pieces of the coating. This showed that adhesion of the coating of the Example 7 panel had not been compromised in 16 weeks of exposure to the highly corrosive environment of the Atlas Cell.

### Example 9

Two ECTFE coated panels, designated Panels A and B, were prepared and tested as follows: Panel A was prepared exactly as in Example 6. Panel B was prepared as in Example 7, except that the underlying Hastelloy® C-276 thermal spray attachment layer was modified to increase atomization of the thermal spray and create a very smooth metallic layer. The surface finish was approximately 5 microns Ra (200 microinches Ra).

Both panels were tested in an Atlas Cell as described in Example 5. Panel A showed blistering after 4 weeks (size 2, medium density per ASTM D714-87), and Panel B showed no blistering or other failure as of 20 weeks. These results indicate that a coatings of the invention formed with a very smooth thermal spray layer are resistant to corrosion.

### Example 10

An Atlas Cell panel was prepared as in Example 3, except that it was primed using a conventional PFA primer (DuPont 420-703) and cured. A PFA slurry was applied (Fluoroshield®, WL Gore) in multiple applications and cured according to the manufacturer's instructions, to form a fluoropolymer coating of 1.5 mm (0.060 inch). The cured coating showed no pinholes when high voltage spark tested.

### Example 11

An Atlas Cell panel was prepared as Example 10, but no primer was used and a 0.3-0.375 mm (0.012-0.015 inch) layer of Hastelloy® C-276 was applied as in Example 4. The PFA coating was 1.5 mm (0.060 inch) thick when cured.

The panels from Example 10 and 11 were tested in an Atlas Cell as described in Example 5. The panel from Example 10 showed blistering after 10 weeks of testing (size 3 blisters, few in number in the cell vapor phase, per ASTM D714-87). After 20 weeks, the blisters on this panel had increased to size 1, and were distributed in liquid and vapor phases although still few in number.

As of 39 weeks in the Atlas Cell, the panel from Example 11 showed no blisters or other sign of failure.

### Example 12

An Atlas Cell panel was prepared similar to the panel in Example 11 except that a stainless steel mesh was spot welded to the thermal spray layer. As in Example 11, the PFA layer was applied to a thickness of 0.060 mils (1.5 mm).

As of 39 weeks in the Atlas Cell, the coating on this panel showed no blisters, loss of adhesion or failure of any kind.

### Example 13

An Atlas Cell panel was prepared as in Example 11, except that the PFA coating was 1 mm (0.040 inch) thick. Atlas Cell testing showed no failure as of 39 weeks.

### Example 14

An Atlas Cell panel was prepared as in Example 11, except that a 0.064-1.6-1.7 mm (0.068 inch) thick PFA layer that included a carbon-rich layer was applied over a 0.15 mm (0.006 inch) layer of Hastelloy® C-276. Atlas Cell testing showed no failure as of 39 weeks.

### Example 15

An Atlas Cell plate was prepared as in Example 3, except that no fluoropolymer layer was applied. The plate (coated only with a Hastelloy® C-276 thermal spray layer) was placed in the Atlas Cell, and gas bubbles were immediately seen in and on the coating surface. These bubbles indicate significant reactivity in the Atlas Cell environment due to the porosity of the thermal spray metallic coating.

### Example 16

For comparison purposes, a sample was prepared according to the teachings of U.S. Pat. No. 5,283,121 of Bordner (“Bordner '121 patent”). An Atlas Cell test plate was grit blasted and coated with Diamalloy 1003 powder (an AISI Type 316 Stainless Steel powder obtained from Sulzer Metco), using the Diamond Jet HVOF gun and standard operating parameters for the powder. Diamalloy powders are specifically sized and designed for the Diamond Jet HVOF System. The composition of the Diamalloy 1003 powder was

| | |
|---|---|
| Cr | 17% |
| Ni | 12 |
| Mo | 2.5 |
| Si | 1 |
| C | 0.1 |
| Fe | Bal |

Nominal particle size was −45+11 microns (−325 mesh+11 microns).

The thermal spray layer was applied to a thickness of 6-8 mils (0.15-0.2 mm) and topcoated with one sprayed layer of Teflon S® (DuPont 958-203 black), which was dried and cured at 600-650° F. The thickness of the topcoat was about 0.05 mm (50 microns).

The plate was fitted to an Atlas Cell and tested per ASTM C868-85 using HCl at a concentration of 2.4N and 80-85° C. (176-185° F.) for three weeks. The plate was then removed from the cell and examined. Severe rusting occurred at the acid/vapor interface, creating blisters and rust discoloration above and below the interface line about 2 cm in each direction. Rust spots were scattered on other areas both above and below the interface. These results show that the coating prepared according to the Bordner '121 patent failed to resist corrosion.

### Example 17

Another sample was prepared according to the Bordner '121 patent using a mixture of Diamalloy 1003 and Metco 41C powders in a ratio of 50/50 wt. %. The Diamalloy 1003 powder is described in Example 16. The properties of the Metco 41C powder (Sulzer Metco) are similar to the Diamalloy 1003 powder in chemistry, except that the Metco 41C powder is water atomized. The Metco 41C powder is also an AISI Type 316 stainless steel powder. The particle size of the Metco 41C powder was −106+45 microns (−140+325 mesh).

The coating was applied with the Diamond Jet HVOF gun using standard parameters to a thickness of 3-5 mils (75-125 microns). The thermal spray coating was then topcoated with Teflon S® as in Example 16.

The coated plate was tested per ASTM C868-85 as in Example 16 and reviewed at the end of three weeks. The Teflon S® had delaminated on 70% of the surface, and the remainder was 100% rust covered. The thermal spray layer had also delaminated in the immersion area of the test. These results show that the coating prepared according to the Bordner '121 patent failed to resist corrosion.

All documents referred to herein are incorporated by reference. While the present invention has been described in connection with the preferred embodiments of the various figures, it is to be understood that other similar embodiments may be used or modifications and additions made to the described embodiments for performing the same function of the present invention without deviating therefrom. Therefore, the present invention should not be limited to any single embodiment, but rather should be construed in breadth and scope in accordance with the recitation of the appended claims.

We claim:

1. A corrosion resistant coating for a metal substrate, comprising a thermally sprayed metallic layer comprising a nickel-based alloy or stainless steel with a thickness of at least about 0.125 mm, and a polymer layer overlaying the metallic layer with a thickness of at least about 0.5 mm, wherein the polymer layer comprises one or more polymers.

2. The coating of claim 1 wherein the polymer layer comprises a polymer selected from the group consisting of polyether sulfone (PES); polyphenylene sulfide (PPS); polyether ether ketone (PEEK); polyphenylene oxide (PPO); elastomers; fluoroelastomers; epoxy; nylon; chlorinated rubber; polyurethane; polyurea; and a fluoropolymer.

3. The coating of claim 2 wherein the polymer comprises a fluoropolymer.

4. The coating of claim 3, wherein the fluoropolymer is selected from the group consisting of polytetrafluoroethylene (PTFE); fluorinated ethylene-propylene copolymer (FEP); perfluoroalkoxy-tetrafluoroethylene copolymer (PFA); tetrafluoroethyleneperfluoromethylvinylether copolymer (MFA); ethylene-chlorotrifluoroethylene copolymer (ECTFE); ethylene-tetrafluoroethylene copolymer (ETFE); and polyvinylidene fluoride (PVDF).

5. The coating of claim 1 wherein the polymer layer is about 0.5 mm to about 3 mm thick.

6. The coating of claim 1 wherein the polymer layer is about 0.75 mm to about 3 mm thick.

7. The coating of claim 1 wherein the polymer layer is about 1 mm to about 2 mm thick.

8. The coating of claim 1 wherein the polymer layer is about 1 mm to about 1.5 mm thick.

9. The coating of claim 1 wherein the metallic layer comprises a nickel-based alloy.

10. The coating of claim 9 wherein the nickel-based alloy is selected from the group consisting of a Ni—Cu alloy; a Ni—Mo alloy; a Ni—Fe—Cr alloy; a Ni—Cr—Si alloy; and a Ni—Cr—Mo alloy.

11. The coating of claim 10 wherein the nickel-based alloy comprises a Ni—Cr—Mo alloy.

12. The coating of claim 11 wherein the Ni—Cr—Mo alloy is UNS No.: N10276.

13. The coating of claim 1 wherein the metallic layer is about 0.25 mm to about 0.5 mm thick.

14. The coating of claim 1, wherein the metallic layer is about 0.25 mm to about 0.375 mm thick.

15. The coating of claim 1, wherein the metallic layer has a surface roughness of at least about 3.125 microns Ra as measured by stylus profilometry.

16. The coating of claim 15, wherein the metallic layer has a surface roughness of at least about 5 microns Ra as measured by stylus profilometry.

17. The coating of claim 1, wherein the polymer layer comprises a sprayed layer or a polymer sheet.

18. The coating of claim 17, wherein the polymer sheet is selected from the group consisting of a bonded thermoplastic liner and an adhesive sheet.

19. A corrosion resistant coating for a metal substrate, comprising a thermally sprayed metallic layer comprising a nickel-based alloy or stainless steel, and a polymer layer comprising one or more polymers overlaying the metallic layer, wherein the coating resists failure for at least 3 weeks according to ASTM protocol C868-85 using 20% hydrochloric acid at 80-85° C. as the corrodant.

20. The corrosion resistant coating of claim 19, wherein the coating resists failure for at least 6 weeks.

21. The corrosion resistant coating of claim 19, wherein the coating resists failure for at least 10 weeks.

22. The corrosion resistant coating of claim 19, wherein the coating resists failure for at least 30 weeks.

23. The coating of claim 19 wherein the polymer layer comprises a polymer selected from the group consisting of polyether sulfone (PES); polyphenylene sulfide (PPS); polyether ether ketone (PEEK); polyphenylene oxide (PPO); elastomers; fluoroelastomers; epoxy; nylon; chlorinated rubber; polyurethane; polyurea; and fluoropolymers.

24. The coating of claim 23 wherein the polymer comprises a fluoropolymer.

25. The coating of claim 24, wherein the fluoropolymer is selected from the group consisting of polytetrafluoroethylene (PTFE); fluorinated ethylene-propylene copolymer (FEP); perfluoroalkoxy-tetrafluoroethylene copolymer (PFA); tetrafluoroethyleneperfluoromethylvinylether copolymer (MFA); ethylene-chlorotrifluoroethylene copolymer (ECTFE); ethylene-tetrafluoroethylene copolymer (ETFE); and polyvinylidene fluoride (PVDF).

26. The coating of claim 19 wherein the metallic layer comprises a nickel-based alloy.

27. The coating of claim 26 wherein the nickel-based alloy is selected from the group consisting of a Ni—Cu alloy; a Ni—Mo alloy; a Ni—Fe—Cr alloy; a Ni—Cr—Si alloy; and a Ni—Cr—Mo alloy.

28. The coating of claim 27 wherein the nickel-based alloy comprises a Ni—Cr—Mo alloy.

29. The coating of claim 28 wherein the Ni—Cr—Mo alloy is UNS No.: N110276.

30. The coating of claim 19, wherein the polymer layer comprises a sprayed layer or a polymer sheet.

31. The coating of claim 30, wherein the polymer sheet is selected from the group consisting of a bonded thermoplastic liner and an adhesive sheet.

32. A metal substrate coated with the corrosion-resistant coating of claim 1.

33. The metal substrate of claim 32 wherein the polymer layer comprises a fluoropolymer.

34. The metal substrate of claim 33, wherein the fluoropolymer is selected from the group consisting of polytetrafluoroethylene (PTFE); fluorinated ethylene-propylene copolymer (FEP); perfluoroalkoxy-tetrafluoroethylene copolymer (PFA); tetrafluoroethylene-perfluoromethylvinylether copolymer (MFA); ethylene-chlorotrifluoroethylene copolymer (ECTFE); ethylene-tetrafluoroethylene copolymer (ETFE); and polyvinylidene fluoride (PVDF).

35. The metal substrate of claim 32 wherein the metallic layer comprises a nickel-based alloy selected from the group consisting of a Ni—Cu alloy; a Ni—Mo alloy; a Ni—Fe—Cr alloy; a Ni—Cr—Si alloy; and a Ni—Cr—Mo alloy.

36. The metal substrate of claim 32 wherein the nickel-based alloy comprises a Ni—Cr—Mo alloy.

37. The metal substrate of claim 32, wherein the polymer layer comprises a sprayed layer or a polymer sheet.

38. The metal substrate of claim 37, wherein the polymer sheet is selected from the group consisting of a bonded thermoplastic liner and an adhesive sheet.

39. A metal substrate coated with the corrosion-resistant coating of claim 19.

40. The metal substrate of claim 39 wherein the polymer layer comprises a fluoropolymer.

41. The metal substrate of claim 40, wherein the fluoropolymer is selected from the group consisting of polytetrafluoroethylene (PTFE); fluorinated ethylene-propylene copolymer (FEP); perfluoroalkoxy-tetrafluoroethylene copolymer (PFA); tetrafluoroethylene-perfluoromethylvinylether copolymer (MFA); ethylene-chlorotrifluoroethylene copolymer (ECTFE); ethylene-tetrafluoroethylene copolymer (ETFE); and polyvinylidene fluoride (PVDF).

42. The metal substrate of claim 39 wherein the metallic layer comprises a nickel-based alloy selected from the group consisting of a Ni—Cu alloy; a Ni—Mo alloy; a Ni—Fe—Cr alloy; a Ni—Cr—Si alloy; and a Ni—Cr—Mo alloy.

43. The metal substrate of claim 42 wherein the nickel-based alloy comprises a Ni—Cr—Mo alloy.

44. The metal substrate of claim 39, wherein the polymer layer comprises a sprayed layer or a polymer sheet.

45. The metal substrate of claim 44, wherein the polymer sheet is selected from the group consisting of a bonded thermoplastic liner and an adhesive sheet.

46. A chemically stable mechanical attachment interface for polymer-based corrosion control coatings, wherein the interface comprises a thermally sprayed metallic layer coating comprising a nickel-based alloy or stainless steel with a thickness of at least about 0.125 mm and a surface roughness of at least 3.125 microns Ra as measured by stylus profilometry.

47. The interface of claim 46 wherein the surface roughness of the interface is at least about 5 microns Ra as measured by stylus profilometry.

48. A method of coating a metal substrate with a corrosion resistant coating, comprising the steps of:
1) providing a metal substrate;
2) forming a stable chemical attachment interface on the metal substrate by coating the metal substrate with a seamless thermal spray metallic coating comprising a nickel-based alloy or stainless steel, wherein the metallic layer has a thickness of at least about 0.125 mm; and
3) applying a polymer layer over the metallic layer, wherein the polymer layer comprises one or more polymers and has a thickness of at least about 0.5 mm.

49. The method of claim 48 wherein the polymer layer comprises a fluoropolymer.

50. The method of claim 49, wherein the fluoropolymer is selected from the group consisting of polytetrafluoroethylene (PTFE); fluorinated ethylene-propylene copolymer (FEP); perfluoroalkoxy-tetrafluoroethylene copolymer (PFA); tetrafluoroethyleneperfluoromethylvinylether copolymer (MFA); ethylene-chlorotrifluoroethylene copolymer (ECTFE); and ethylene-tetrafluoroethylene copolymer (ETFE); polyvinylidene fluoride (PVDF).

51. The method of claim 48 wherein the metallic layer comprises a nickel-based alloy.

52. The method of claim 51 wherein the nickel-based alloy is selected from the group consisting of a Ni—Cu alloy; a Ni—Mo alloy; a Ni—Fe—Cr alloy; a Ni—Cr—Si alloy; and a Ni—Cr—Mo alloy.

53. The method of claim 52 wherein the nickel-based alloy comprises a Ni—Cr—Mo alloy.

54. The method of claim 53 wherein the Ni—Cr—Mo alloy is UNS No.: N10276.

55. The method of claim 48 wherein the polymer layer is applied by the process of spraying; rotolining; transfer molding; sheet bonding; or bonding to a mesh screen.

56. The method of claim 55 wherein process of spraying is selected from the group consisting of spray and bake; spraying of a slurry; electrostatic spraying; thermal spraying; and flocking.

57. A method of coating a metal substrate with a corrosion resistant coating, comprising the steps of:
1) providing a metal substrate;
2) forming a stable chemical attachment interface on the metal substrate by coating the metal substrate with a seamless thermal spray metallic coating comprising a nickel-based alloy or stainless steel; and
3) applying a polymer layer comprising one or more polymers over the metallic layer,
wherein the coating resists failure for at least 3 weeks according to ASTM protocol C868-85 using 20% hydrochloric acid at 80-85° C. as the corrodant.

58. The corrosion resistant coating of claim 57, wherein the coating resists failure for at least 6 weeks.

59. The corrosion resistant coating of claim 57, wherein the coating resists failure for at least 10 weeks.

60. The corrosion resistant coating of claim 57, wherein the coating resists failure for at least 30 weeks.

61. The method of claim 57 wherein the polymer layer comprises a fluoropolymer.

62. The method of claim 61, wherein the fluoropolymer is selected from the group consisting of polytetrafluoroethylene (PTFE); fluorinated ethylene-propylene copolymer (FEP); perfluoroalkoxy-tetrafluoroethylene copolymer (PFA); tetrafluoroethyleneperfluoromethylvinylether copolymer (MFA); ethylene-chlorotrifluoroethylene copolymer (ECTFE); and ethylene-tetrafluoroethylene copolymer (ETFE); polyvinylidene fluoride (PVDF).

63. The method of claim 57 wherein the metallic layer comprises a nickel-based alloy.

64. The method of claim 63 wherein the nickel-based alloy is selected from the group consisting of a Ni—Cu alloy; a Ni—Mo alloy; a Ni—Fe—Cr alloy; a Ni—Cr—Si alloy; and a Ni—Cr—Mo alloy.

65. The method of claim 64 wherein the nickel-based alloy comprises a Ni—Cr—Mo alloy.

66. The method of claim 65 wherein the Ni—Cr—Mo alloy is UNS No.: N110276.

67. The method of claim 48 wherein the polymer layer is applied by the process of spraying; rotolining; transfer molding; sheet bonding; or bonding to a mesh screen.

68. The method of claim 67 wherein process of spraying is selected from the group consisting of spray and bake; spraying of a slurry; electrostatic spraying; thermal spraying; and flocking.

69. The coating of claim 1 or claim 19, wherein the polymer layer overlaying the metallic layer contacts a mesh screen that is attached to the metallic layer.

70. The metal substrate of claim 32, wherein the polymer layer overlaying the metallic layer contacts a mesh screen that is attached to the metallic layer.

71. The method of claim 48 or 57, wherein a mesh screen is attached to the metallic layer prior to application of the polymer layer, and the polymer layer is applied over the metallic layer and mesh screen.
